(19) United States
(12) Patent Application Publication
(10) Pub. No.: US 2018/0313118 A1
(43) Pub. Date: Nov. 1, 2018

(54) VEHICLE DOOR LATCH APPARATUS

(71) Applicant: MITSUI KINZOKU ACT CORPORATION, Yokohama-shi (JP)

(72) Inventor: Hiroki HATTORI, Yokohama-shi (JP)

(21) Appl. No.: 15/950,577

(22) Filed: Apr. 11, 2018

(30) Foreign Application Priority Data
Apr. 29, 2017 (JP) 2017-090886

(51) Int. Cl. E05B 77/06; E05B 83/36; E05B 85/24; E05B 85/26

(52) U.S. Cl. CPC E05B 77/06; E05B 85/26; E05B 85/243; E05B 83/36

(57) ABSTRACT

A vehicle door latch apparatus has a latch, a ratchet, an opening lever that rotates the ratchet in an releasing direction in a door opening operation and a ratchet holding mechanism that prevents the ratchet from being rotated in the releasing direction when the opening lever is unexpectedly rotated in a door opening direction. The ratchet holding mechanism includes an inertial lever that has a ratchet holding surface. The ratchet holding surface abuts against a convex part of the ratchet when the ratchet is rotated in the releasing direction, and thereby prevents the ratchet from being rotated in the releasing direction. The ratchet holding surface is positioned out of a trajectory of the convex part when the inertial lever is rotated about a supporting shaft in the door opening operation, and thereby allows the ratchet to be rotated in the releasing direction.

The present application is based on, and claims priority from, J.P. Application No. 2017-090886, filed on Apr. 29, 2017, the disclosure of which is hereby incorporated by reference herein in its entirety.

### BACKGROUND OF THE INVENTION

### 1. Field of the Invention

The present invention relates to a vehicle door latch apparatus, and particularly to a ratchet holding mechanism of a vehicle door latch apparatus that prevents the unexpected opening of a vehicle door.

### 2. Prior Art of the Invention

In conventional vehicle door latch apparatuses, when a door panel is deformed in a car accident, the door panel that was deformed may displace a connecting cable or a connecting rod that extends to a ratchet. The connecting cable or the connecting rod that was displaced may rotate the ratchet in the releasing direction. The ratchet, in turn, may disengage a latch in a full-latched position and cause unexpected opening of the door.

JP 2016-505098 discloses a ratchet holding mechanism for a vehicle door latch apparatus that prevents the unexpected opening of a door. When the ratchet is rotated in the releasing direction, whether the rotation was caused by a user of the vehicle who operated a door opening handle or whether the rotation was caused by a door panel that was deformed, is distinguished based on the rotation speed of the ratchet. When the rotation speed is high, the ratchet is prevented from being rotated in the releasing direction in order to cope with an unexpected situation.

### SUMMARY OF THE INVENTION

In the vehicle door latch apparatus disclosed in JP2016-505098, the ratchet holding mechanism works only when the door opening lever (release lever), which rotates the ratchet during a door opening operation via the door opening handle of a door, is physically rotated at a high speed (or with an increased rotational acceleration) by a door panel that was deformed. That is, the operation of the ratchet holding mechanism requires the rotation of the opening lever, and when something abnormal is not found in the opening lever, the ratchet holding mechanism does not work.

Thus, it is impossible to prevent the rotation of a ratchet in the releasing direction that is caused, not by physical pressure, such as deformation of a door panel, but by the moment of inertia that results from impact on a vehicle. More specifically, due to symmetry of the driver's side door and the passenger's side door, when a vehicle experiences a large impact, the ratchet on one side is subjected to the moment of inertia in the direction in which the ratchet engages the latch (an anti-releasing direction), depending on the position of the center of gravity of the ratchet, while the ratchet on the other side is subjected to the moment of inertia in the releasing direction. Thus, it is difficult to simultaneously prevent the ratchets of the doors on both sides from being rotated in the releasing direction by the moment of inertia.

According to the invention, a vehicle door latch apparatus comprises: a latch that engages a door striker and that is rotatable between an unlatched position and a full-latched position; a ratchet comprising a claw that is engageable with a full-latch engagement part of the latch, wherein the ratchet keeps the latch in the full-latched position by the claw engaging the full-latch engagement part; an opening lever that rotates the ratchet in a releasing direction in a door opening operation via a door opening handle in order to disengage the claw from the full-latch engagement part; and a ratchet holding mechanism that prevents the ratchet from being rotated in the releasing direction when the opening lever is unexpectedly rotated in a door opening direction. The ratchet holding mechanism includes an inertial lever that has a ratchet holding surface. The ratchet holding surface abuts against a convex part of ratchet when the ratchet is rotated in the releasing direction, and thereby prevents the ratchet from being rotated in the releasing direction. The ratchet holding surface is positioned out of a trajectory of the convex part when the inertial lever is rotated about a supporting shaft in the door opening operation via the door opening handle, and thereby allows the ratchet to be rotated in the releasing direction.

The rotation of the ratchet in the releasing direction is only allowed when the door opening handle is operated in order to open the door, regardless of whether the door is opened normally or unexpectedly, and therefore, unexpected rotation of the ratchet in the releasing direction can be effectively prevented. Furthermore, due to the simple structure of the invention, it is expected that the ratchet is prevented from being unexpectedly rotated in the releasing direction even when damage occurs on the vehicle door latch apparatus.

The above and other objects, features and advantages of the present invention will become apparent from the following description with reference to the accompanying drawings which illustrate examples of the present invention.

### BRIEF DESCRIPTION OF THE DRAWINGS

FIG. 1 is a perspective view of a vehicle door latch apparatus according to the present invention;

FIG. 2 is an exploded perspective view of the vehicle door latch apparatus;

FIG. 3 is a rear view of a latch unit of the vehicle door latch apparatus;

FIG. 4 is a perspective view of the latch unit and a ratchet holding mechanism, seen from the rear side;

FIG. 5 is an exploded perspective view of the ratchet holding mechanism, seen from the front side;

FIG. 6 is a rear view of a ratchet of the latch unit;

FIG. 7 is a rear view of a ratchet lever of the latch unit;

FIG. 8 is a rear view of an inertial lever of the ratchet holding mechanism;

FIG. 9 is a rear view of a blocking lever of the ratchet holding mechanism;

FIG. 10 is a rear view of a latch unit in the full-latched state;

FIG. 11 is an enlarged view of the convex part of the ratchet and the upper part of the ratchet holding mechanism in FIG. 10;

FIG. 12 is a rear view of the latch unit in a state where the inertial lever is rotated during a door opening operation via an inner or an outer door opening handle and where the claw of the ratchet is disengaged from the full-latch engagement part of the latch after the ratchet is rotated in the releasing direction;

FIG. 13 is an enlarged view of the convex part of the ratchet and the upper part of the ratchet holding mechanism in FIG. 12.

FIG. 14 is a rear view of the latch unit in a state where the blocking lever of the ratchet holding mechanism abuts against the stopper and the ratchet is thereby prevented from being rotated in the releasing direction;

FIG. 15 is an enlarged view of the convex part of the ratchet and the upper part of the ratchet holding mechanism in FIG. 14;

FIG. 16 is a rear view of the latch unit in a state where the convex part of the ratchet abuts against the ratchet holding surface of the inertial lever and the ratchet is thereby prevented from being rotated in the releasing direction; and

FIG. 17 is an enlarged view of the convex part of the ratchet and the upper part of the ratchet holding mechanism in FIG. 16.

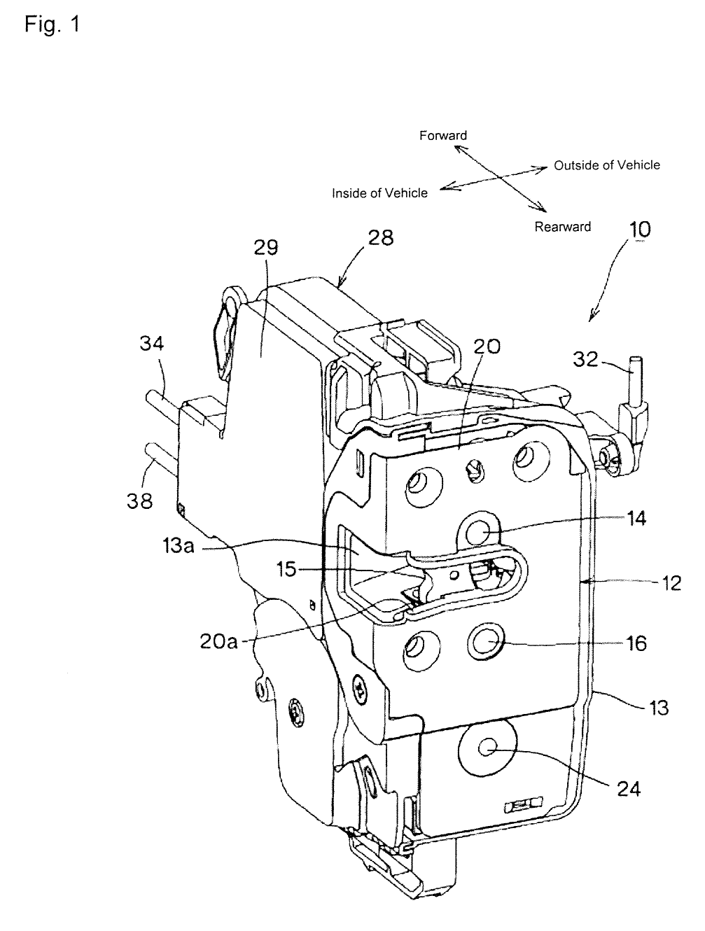

### DESCRIPTION OF EMBODIMENTS

Hereinafter, an embodiment of the present invention will be explained with reference to the drawings. The directions in the drawings are shown based on a vehicle (front door) to which door latch apparatus 10 is attached, and the directions may be changed depending on the type of the vehicle door.

Vehicle door latch apparatus 10 has latch unit 12 that engages striker 11 that is attached to a vehicle door. Latch unit 12 has latch body 13 that is made of synthetic resin. On the rear side of latch body 13, latch 15 and ratchet 17 (FIG. 6) are rotataby supported by latch shaft 14 and ratchet shaft 16, respectively. Ratchet 17 is rotatable between a first position where ratchet 17 engages latch 15 in the full-latched position and keeps latch 15 in the full-latched position and a second position where ratchet 17 is disengaged from latch 15 in order to allow latch 15 to return to the unlatched position.

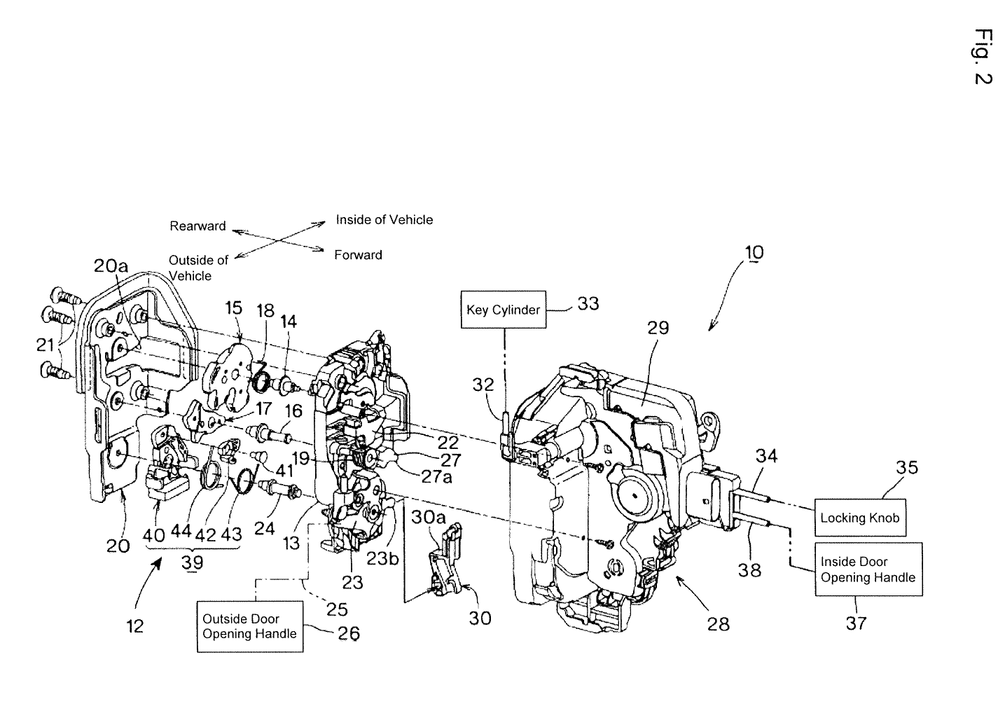

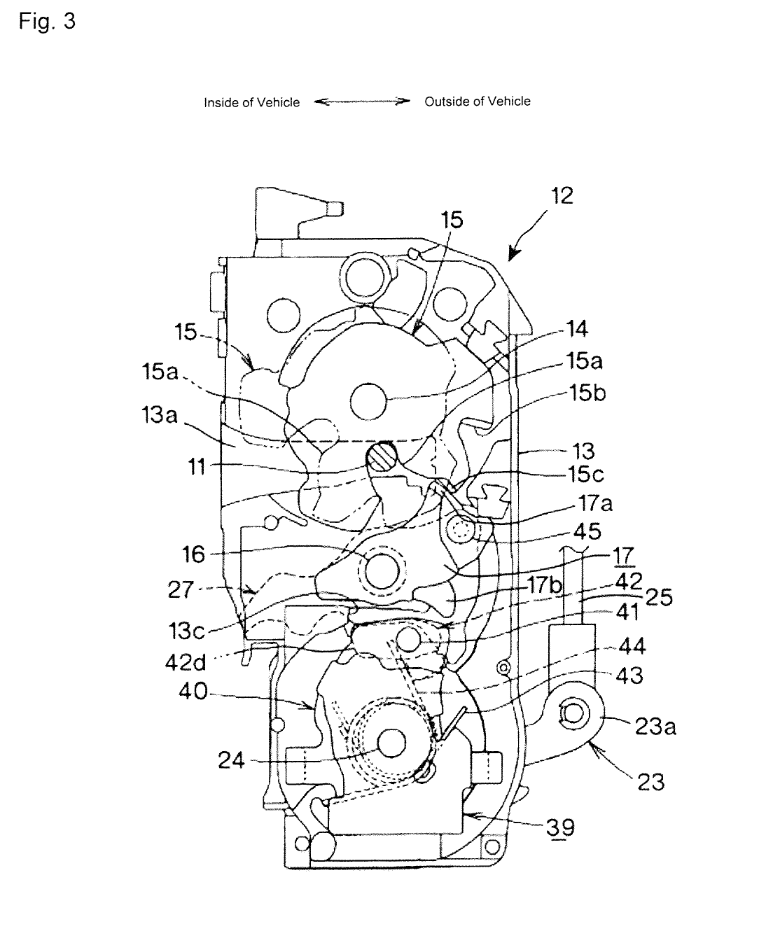

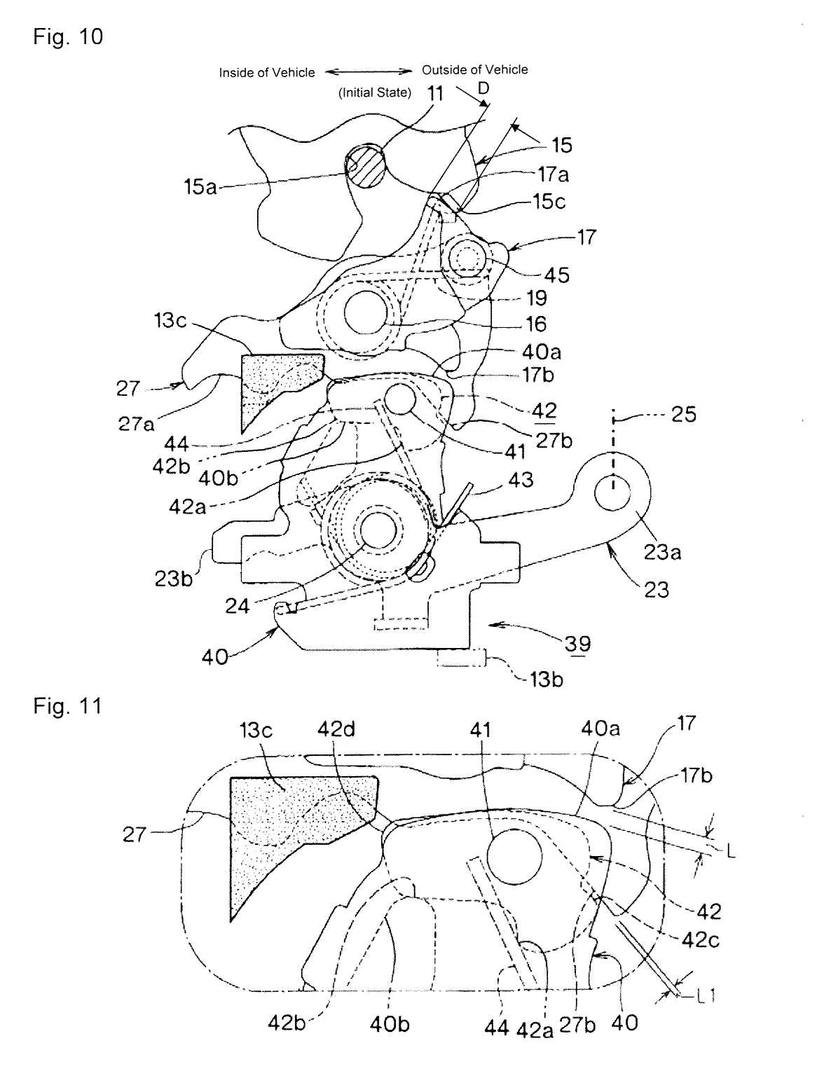

When the door is moved in the door closing direction, striker 11 enters striker passage 13a that is formed in latch body 13 and abuts against striker engagement groove 15a of latch 15 in the unlatched position, which is shown with an imaginary line in FIG. 3. When striker 11 abuts against striker engagement groove 15a, latch 15 is rotated from the unlatched position toward the full-latched position (in the counterclockwise direction) against the elastic force of latch spring 18 (FIG. 2). When latch 15 reaches the half-latch position, claw 17a of ratchet 17, which is biased in the counterclockwise direction (in the latch engaging direction) by the elastic force of ratchet spring 19 (see FIG. 2 and FIG. 10), is pushed to a position that allows claw 17a to engage half-latch engagement part 15b of latch 15. When latch 15 reaches the full-latched position, claw 17a of ratchet 17 is pushed to a position that allows claw 17a to engage full-latch engagement part 15c of latch 15. When claw 17a of ratchet 17 engages full-latch engagement part 15c, latch 15 is kept in the full-latched position and the door is kept closed.

The rear side of latch body 13 is covered with metallic cover plate 20 (conventionally, it is called, not ‘a back plate’, but ‘a cover plate’ regardless of where it is attached) except striker passage 13a of latch body 13. Cut-out passage 20a that corresponds to striker passage 13a is formed in metallic cover plate 20.

Latch body 13 is attached to the rear end of the vehicle door by means of bolts 21 (FIG. 2). When the vehicle door is a type of a commonly used swing door, the center axes of latch shaft 14 and ratchet shaft 16 extend in the front-rear direction, and striker passage 13a is arranged horizontally.

Metallic back plate 22 (FIG. 2) is provided on the front side of latch body 13. At the lower part of back plate 22, opening lever 23 that extends in the vehicle interior-outside direction (in the door width direction) is rotatably supported by supporting shaft 24. End 23a of opening lever 23 that is located on the outer side of the vehicle is connected to outer door opening handle 26 (FIG. 2) via connector 25, such as a Bowden cable or a rod.

In the center of the front side of latch body 13, ratchet lever 27 that is rotated with ratchet 17 is provided. As will described later, when ratchet lever 27 is rotated in the releasing direction (in the direction in which ratchet 17 is disengaged from latch 15), for example, during a door opening operation via opening lever 23, latch 15 is released and the door is put in an openable state. Ratchet 17 is preferably connected to ratchet lever 27 by means of connecting pin 45.

Operation unit 28 is provided in front of latch unit 12. Housing 29 of operation unit 28 is fixed to latch body 13 such that it covers the front surface of latch body 13. A door opening mechanism, a locking mechanism and so on are provided in housing 29.

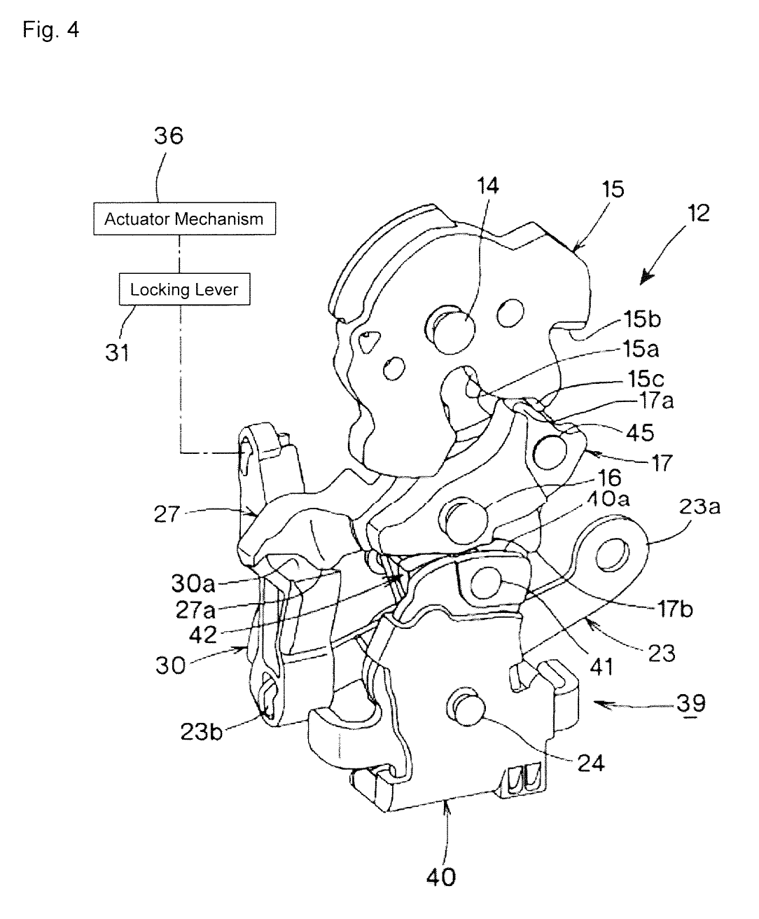

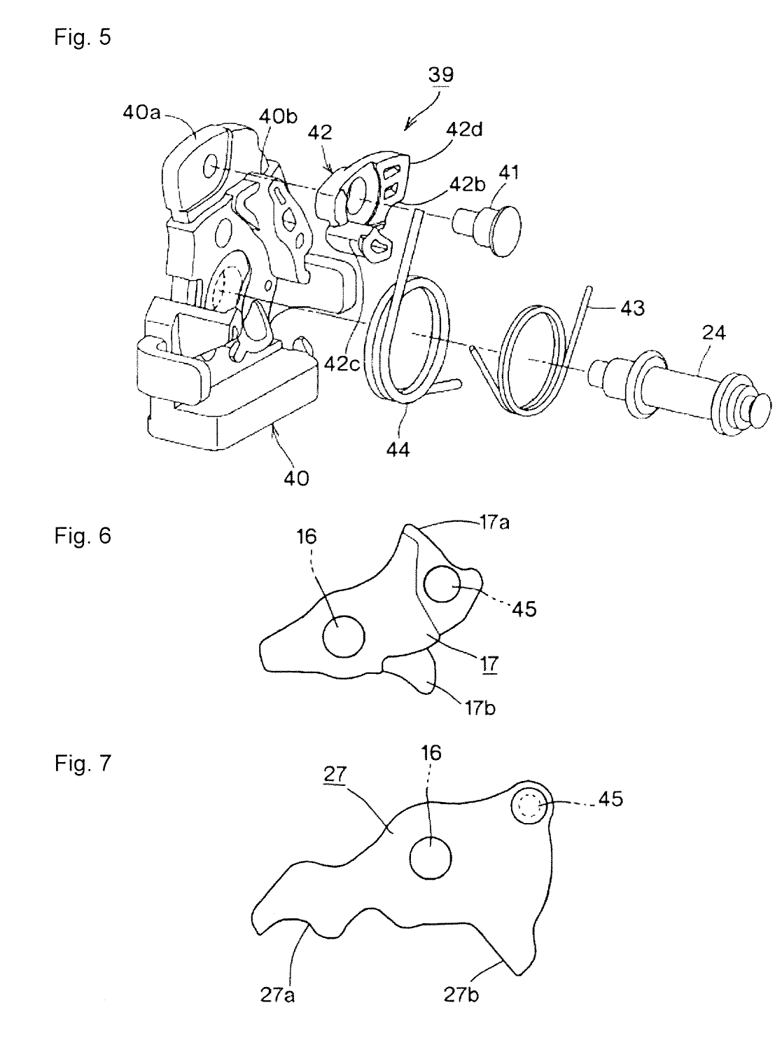

The door opening mechanism disengages ratchet 17 from latch 15. The door opening mechanism has opening link 30 (refer to FIG. 2 and FIG. 4). The bottom of opening link 30 is connected to end 23b of opening lever 23 on the interior side of the vehicle, and is raised by door opening operation via outer door opening handle 26.

The locking mechanism has locking lever 31 that shifts opening link 30 (FIG. 4) between the unlocked position and the locked position. In the unlocked position, contact stepped part 30a of opening link 30 on the vehicle interior side is opposite to end 27a of ratchet lever 27 in the vertical direction. When opening link 30 is raised, opening link 30 engages end 27a of ratchet lever 27 on the vehicle interior side, rotates ratchet 17 in the releasing direction via ratchet lever 27, and thereby disengages ratchet 17 from latch 15. On the other hand, when opening link 30 is shifted to the locked position by rotating locking lever 31, contact stepped part 30a is moved away from the position beneath end 27a of ratchet lever 27 on the vehicle interior side. Thus, ratchet lever 27 is not rotated and latch 15 is not released when opening link 30 is raised.

The locking mechanism is connected to door key cylinder 33 via connector 32, such as a Bowden cable or a rod. Similarly, the locking mechanism is also connected to locking knob 35 via connector 34, such as a Bowden cable or a rod. The locking mechanism can also be switched between the locked position and the unlocked position by means of actuator mechanism 36 that is accommodated in housing 29.

Inner door opening handle 37 of the vehicle door (FIG. 2) is connected to opening link 30 of the door opening mechanism via connector 38, such as a Bowden cable or a rod. Opening link 30 is also raised by the door opening operation via inner door opening handle 37. It should be noted that when a so-called one motion door opening mechanism is adopted, the door opening operation via inner door opening handle 37 is transmitted to ratchet lever 27 by bypassing opening link 30.

Next, ratchet holding mechanism 39, which characterizes the present invention, will be explained.

As clearly illustrated in FIG. 2 and FIG. 3, ratchet holding mechanism 39 is arranged at the lower part of the rear side of latch body 13, and is covered with cover plate 20 in the same manner as latch 15 and ratchet 17. Ratchet holding mechanism 39 has first and second functions to prevent the door from unexpectedly opening.

The first function, that prevent the door from unexpectedly opening, immediately and physically prevents ratchet 17 from being rotated in the releasing direction and thereby prevents claw 17a from being disengaged from full-latch engagement part 15c in a situation in which the door is closed (claw 17a of ratchet 17 engages full-latch engagement part 15c of latch 15) and in which ratchet 17 is rotated in the releasing direction against the elastic force of ratchet spring 19 in an unforeseen situation. The first function that prevents the door from unexpectedly opening is a very effective way to prevent opening of the door.

Unexpected releasing rotation of ratchet 17 may occur due to the moment of inertia that is caused by impact on a vehicle, such as a car accident, and may also occur when connectors 25, 38 etc. are physically displaced by a door panel that was deformed.

Next, releasing rotation of ratchet 17 due to the moment of inertia will be described. Assume that the center of gravity of ratchet 17 (including ratchet lever 27, which is rotated with ratchet 17) in FIG. 10 is positioned above the axis of ratchet shaft 16. When a strong external force is applied from the exterior of the vehicle to the interior of the vehicle, ratchet 17 is subjected to the moment of inertia in the releasing direction (the clockwise direction) because the center of gravity is above the axis of ratchet shaft 16. Depending on the magnitude of the moment of inertia in the releasing direction, claw 17a of ratchet 17 may be disengaged from full-latch engagement part 15c. This causes the door to unexpectedly open which is triggered by the moment of inertia.

It should be noted that the occurrence of the moment of inertia in the releasing direction cannot be prevented by locating the center of gravity of ratchet 17 below the axis of ratchet shaft 16. Specifically, when the center of gravity of ratchet 17 is located below the axis of ratchet shaft 16, the ratchet of the opposite door is subjected to the moment of inertia in the releasing direction because the ratchet of the opposite door and ratchet 17 in FIG. 10 are in symmetry. The occurrence of the moment of inertia can be effectively prevented on both sides of the ratchets by matching the center of gravity of ratchet 17 with the axis of ratchet shaft 16. However, this requires a balance weight or the like.

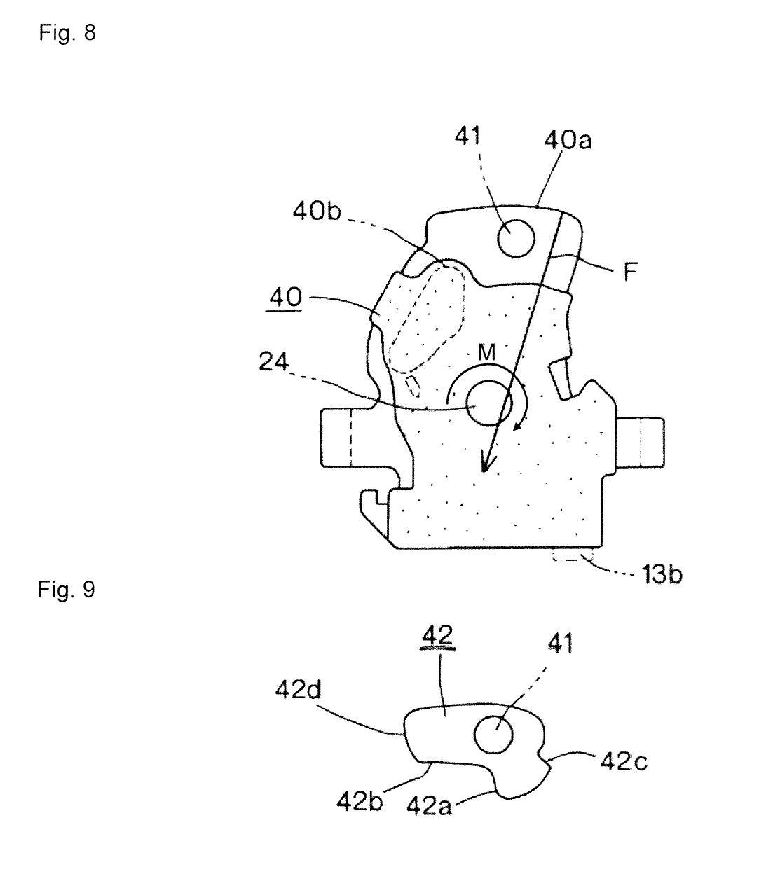

A structure for achieving the first function that prevents the door from unexpectedly opening will be described. Ratchet holding mechanism 39 has inertial lever 40 (FIG. 8) that is rotatably supported by supporting shaft 24. Inertial lever 40 is a single lever that is coated with resin, as shown in FIG. 8. Inertial lever 40 is connected to one end of weak spring 43 (a first spring) and the other end of weak spring 43 is connected to latch body 13. Inertial lever 40 is biased in the clockwise direction relative to latch body 13 in FIG. 10, and is kept in an initial state (a standby state) by weak constraint force of weak spring 43, in which inertial lever 40 is in contact with contact part 13b that is formed on latch body 13.

Ratchet 17 includes convex part 17b that is formed on a part of ratchet 17 that is opposite to claw 17a. Arc-shaped ratchet holding surface 40a is formed on the upper periphery of inertial lever 40. The center of the arc of ratchet holding surface 40a is shifted rightward from the center of supporting shaft 24 by about 2 mm. When the door is closed, convex part 17b is opposite to ratchet holding surface 40a with first gap L therebetween (see FIG. 11).

First gap L is set shorter than the engagement length (first distance D) between claw 17a of ratchet 17 and full-latch engagement part 15c (or half-latch engagement part 15b) of latch 15. With this arrangement, when the moment of inertia is applied to ratchet 17 in the releasing direction and thereby ratchet 17 (and ratchet lever 27 that is integrally connected to ratchet 17) is rotated in the releasing direction, convex part 17b abuts against ratchet holding surface 40a before ratchet 17 is disengaged from latch 15.

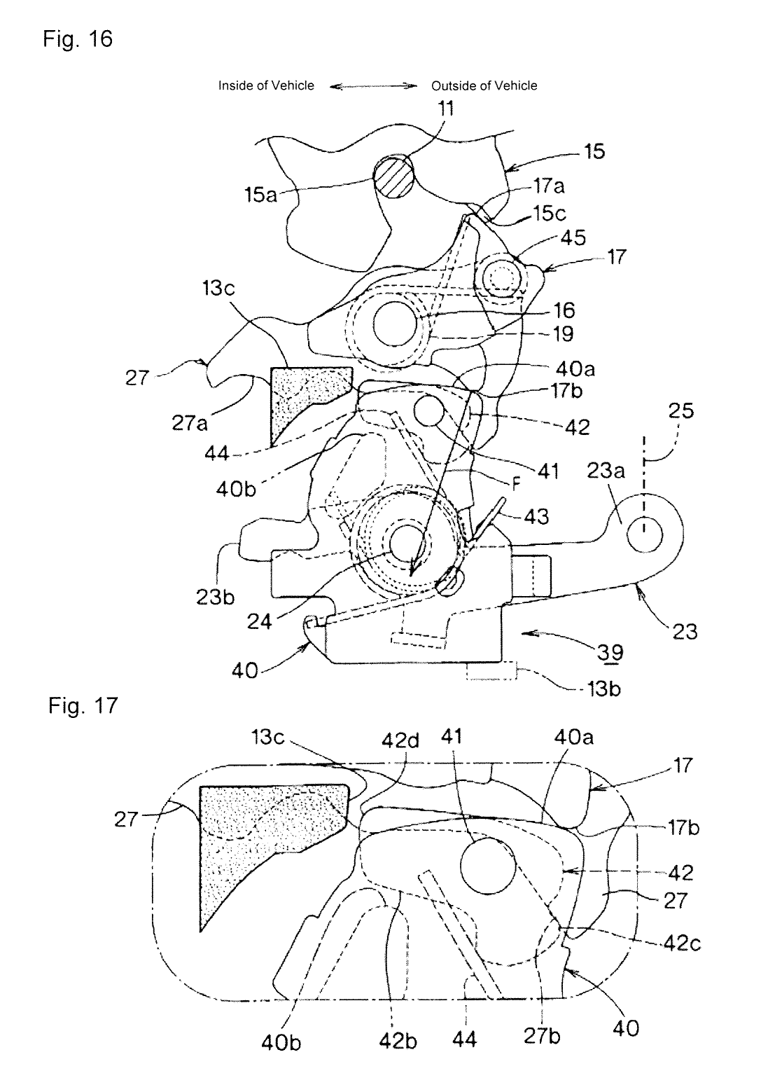

When convex part 17b abuts against ratchet holding surface 40a, inertial lever 40 is subjected to reaction force F, as shown in FIG. 8 and FIG. 16. Since ratchet holding surface 40a is shifted rightward, reaction force F passes on the right side of the axis of supporting shaft 24 of inertial lever 40 and generates moment M that rotates inertial lever 40 in the clockwise direction (FIG. 8). Inertial lever 40 is prevented from being further rotated in the clockwise direction by contact part 13b, against which inertial lever 40 abuts. Thus, moment M that is generated by reaction force F is absorbed by contact part 13b (latch body 13), and the releasing rotation of ratchet 17 is prevented. Therefore, even when unexpected moment of inertia M that causes the releasing rotation of ratchet 17 occurs, ratchet holding mechanism 39 prevents ratchet 17 from being disengaged from latch 15. This is the first function that prevented the door from unexpectedly opening and is achieved due to the operation of ratchet holding mechanism 39.

The first function that prevents the door from unexpectedly opening is a way to prevent opening of the door that works effectively when convex part 17b of ratchet 17 is opposite to ratchet holding surface 40a of inertial lever 40. The simple construction of the first function that prevents the door from unexpectedly opening ensures that the first function works safely even when latch unit 12 itself is seriously damaged.

The first function that prevents the door from unexpectedly opening due to the operation of ratchet holding mechanism 39 is cancelled when inner door opening handle 37 or outer door opening handle 26 is normally operated in order to open the door. Though details will be described later, when inner door opening handle 37 or outer door opening handle 26 is normally operated, inertial lever 40 is rotated counterclockwise about supporting shaft 24 in order to cancel the state in which ratchet holding surface 40a of inertial lever 40 is opposite to convex part 17b of ratchet 17. This allows ratchet 17 to be rotated in the releasing direction.

The second function that prevents the door from unexpectedly opening due to the operation of ratchet holding mechanism 39 physically prevents ratchet 17 from being rotated in the releasing direction when ratchet 17 is rotated in the releasing direction against the elastic force of ratchet spring 19 at an abnormally high speed, and prevents claw 17a from being disengaged from full-latch engagement part 15c of latch 15.

High speed rotation of ratchet 17 in the releasing direction may occur due to the above-described moment of inertia and may also occur when force that deforms the door panel is physically transmitted to ratchet lever 27 via connector 38 or 25.

Next, the structure for achieving the second function that prevents the door from unexpectedly opening due to the operation of ratchet holding mechanism 39 will be described. Blocking lever 42 (FIG. 9) is supported by inertial lever 40 of ratchet holding mechanism 39 via connecting pin 41. When ratchet lever 27 abuts against blocking lever 42 at a low speed, blocking lever 42 accompanies inertial lever 40 and is rotated together with inertial lever 40. When ratchet lever 27 abuts against blocking lever 42 at a high speed, blocking lever 42 is rotated alone without inertial lever 40. Inertial lever 40 is connected to one end of strong spring 44 (a second spring), and the other end of strong spring 44 is connected to latch part 42a of blocking lever 42. Inertial lever 40 is connected to blocking lever 42 by the elastic force of the spring, and blocking lever 42 is biased in the counterclockwise direction in FIG. 3 and FIG. 10 about connecting pin 41 by strong spring 44. It should be noted that the elastic force of strong spring 44 is set larger than the elastic force of weak spring 43.

Blocking lever 42 and strong spring 44 are preferably mounted on inertial lever 40 as a subassembly in advance. The center of gravity of the subassembly is preferably positioned as close to the axis of supporting shaft 24 as possible. This can limit the moment that is applied to inertial lever 40 when the vehicle experiences a large impact.

Contact part 42b is provided on the lower surface of blocking lever 42. Blocking lever 42 is kept in the initial position where contact part 42b is in contact with the upper end of blocking lever holding part 40b by the biasing force of strong spring 44. Blocking lever holding part 40b is provided on the front side of inertial lever 40.

Blocking surface 42d is provided on the side surface of blocking lever 42. When blocking lever 42 is rotated in the clockwise direction about connecting pin 41 against the strong elastic force of strong spring 44, blocking surface 42d protrudes upward far beyond inertial lever 40 (moves to the blocked position). Latch body 13 is provided with stopper 13c that can abut against blocking surface 42d in the blocked position.

Latchet lever 27 is provided with pressing portion 27b on the vehicle outer end part thereof. Pressing portion 27b is opposite to stepped part 42c of blocking lever 42 with gap L1 that is smaller than gap L therebetween. Gap L1 may substantially be zero. When ratchet lever 27 is rotated in the releasing direction via opening link 30, pressing portion 27b abuts against stepped part 42c of blocking lever 42, thereby presses blocking lever 42 in the clockwise direction. It should be noted that ratchet 17 does not touch blocking lever 42 when ratchet 17 is rotated because blocking lever 42 and ratchet 17 are arranged on different rotational planes.

If ratchet lever 27 presses blocking lever 42 at a normal pressing speed, that is, if the pressing speed is not more than the maximum speed for a manual door opening operation via inner door opening handle 37 or outer door opening handle 26, then the pressing force that is applied to blocking lever 42 is transmitted to inertial lever 40 via the strong elastic force of strong spring 44.

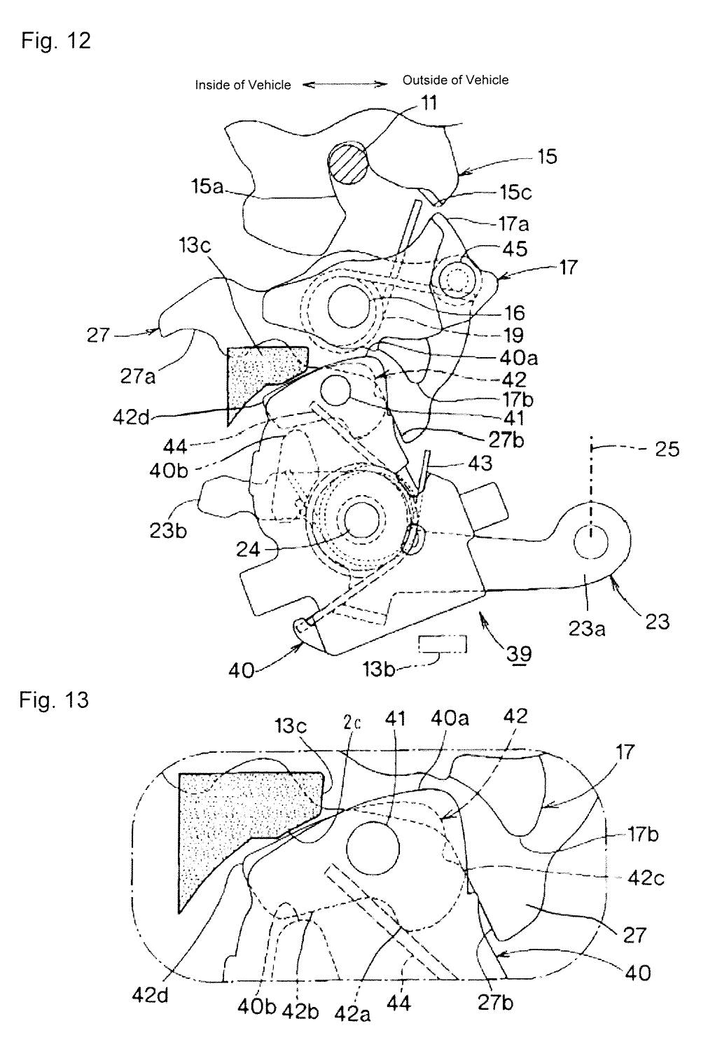

Inertial lever 40 is biased in the clockwise direction by the weak elastic force of weak spring 43 and is kept in the standby state in which inertial lever 40 is in contact with contact part 13b of latch body 13. Inertial lever 40 is rotated in the counterclockwise direction (in the releasing direction) about supporting shaft 24 by the pressing force via strong spring 44. This cancels both the state in which ratchet holding surface 40a of inertial lever 40 is opposite to convex part 17b of ratchet 17 (refer to FIG. 12 and FIG. 13) and the first function that prevents the door from unexpectedly opening due to the operation of ratchet holding mechanism 39. Thus, ratchet 17 is allowed to be rotated in the releasing direction and the door is put in the openable state. It should be noted that when inertial lever 40 is rotated in the releasing direction, blocking lever 42 is not rotated to the blocked position because blocking lever 42 is, in practice, not rotated about connecting pin 41.

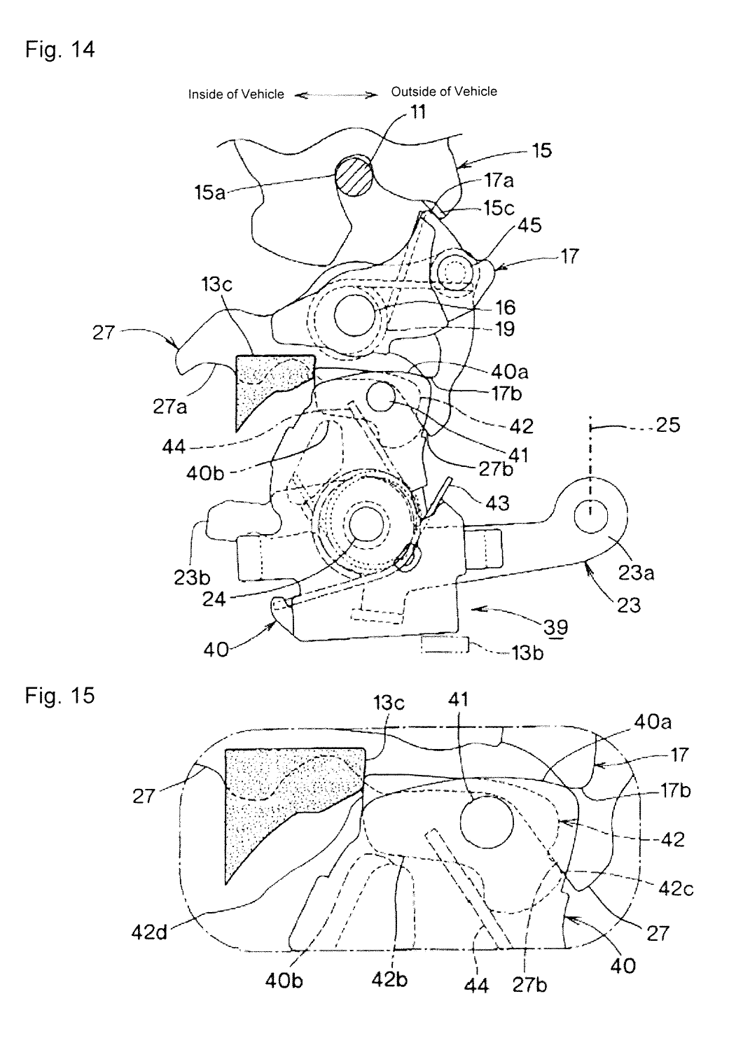

On the other hand, when ratchet lever 27 presses blocking lever 42 at a pressing speed that is more than the maximum speed for a manual door opening operation, unexpected pressing force is instantaneously applied to blocking lever 42. The unexpected pressing force rotates blocking lever 42 clockwise about connecting pin 41 to the blocked position against the strong elastic force of strong spring 44. In the blocked position, blocking surface 42d is opposite to stopper 13c of latch body 13 in an engageable manner and prevents inertial lever 40 from being rotated in the counterclockwise direction about supporting shaft 24 (refer to FIG. 14 and FIG. 15).

Since inertial lever 40 is prevented from being rotated in the counterclockwise direction about supporting shaft 24, as shown in FIG. 14 and FIG. 15, convex part 17b of ratchet 17t is kept opposite to ratchet holding surface 40a of Inertial lever 40. Thus, the releasing rotation of ratchet 17 is prevented.

It should be noted that when ratchet lever 27 presses blocking lever 42 at a still larger pressing speed, blocking lever 42 may be rotated clockwise alone and inertial lever 40 may be kept at the original position without rotation, as shown in FIG. 16 and FIG. 17. However, this state is functionally similar to the state achieved by the first function that prevents the door from unexpectedly opening due to the operation of ratchet holding mechanism 39, in which convex part 17b of ratchet 17 is kept opposite to ratchet holding surface 40a of inertial lever 40. Therefore, the releasing rotation of ratchet 17 is prevented.

As described above, ratchet holding mechanism 39 according to the present invention quickly blocks the releasing rotation of ratchet 17 and prevents the door from unexpectedly opening both when ratchet 17 is unexpectedly rotated in the releasing direction due to the deformation of a door panel and when ratchet 17 is rotated in the releasing direction by the moment of inertia that is caused by impact on the vehicle.

Although a certain preferred embodiments of the present invention have been shown and described in detail, it should be understood that various changes and modifications may be made without departing from the spirit or scope of the appended claims.

What is claimed is:

1. A vehicle door latch apparatus comprising:
a latch that engages a door striker and that is rotatable between an unlatched position and a full-latched position;
a ratchet comprising a claw that is engageable with a full-latch engagement part of the latch, wherein the ratchet keeps the latch in the full-latched position by the claw engaging the full-latch engagement part;
an opening lever that rotates the ratchet in an releasing direction during door opening operation via a door opening handle in order to disengage the claw from the full-latch engagement part; and
a ratchet holding mechanism that prevents the ratchet from being rotated in the releasing direction when the opening lever is unexpectedly rotated in a door opening direction;
wherein the ratchet holding mechanism includes an inertial lever that has a ratchet holding surface, wherein the ratchet holding surface abuts against a convex part of the ratchet when the ratchet is rotated in the releasing direction, and thereby prevents the ratchet from being rotated in the releasing direction;
wherein the ratchet holding surface is positioned out of a trajectory of the convex part when the inertial lever is rotated about a supporting shaft during the door opening operation via the door opening handle, and thereby allows the ratchet to be rotated in the releasing direction.

2. A vehicle door latch apparatus according to claim 1, wherein the ratchet holding mechanism includes a blocking lever that is supported by the inertial lever via a connecting pin, wherein the blocking lever receives rotational force that is generated by the opening lever and is positioned out of the trajectory of the convex part of ratchet,
wherein the inertial lever receives the rotational force via the blocking lever and is rotatable about the supporting shaft by the rotational force.

3. A vehicle door latch apparatus according to claim 2, wherein the inertial lever is kept at an initial position by elastic force of a weak spring, and the rotational force of the blocking lever is transmitted to the inertial lever via elastic force of a strong spring having larger elastic force than the weak spring.

4. A vehicle door latch apparatus comprising:
a latch that engages a door striker and that is rotatable between an unlatched position and a full-latched position;
a ratchet that is rotatable between a first position where the ratchet engages the latch in the full-latched position and that keeps the latch in the full-latched position and a second position where the ratchet is disengaged from the latch in order to allow the latch to return to the unlatched position, and
a ratchet lever that is connected to door opening means and that is integral with the ratchet,
wherein the ratchet is rotated from the first position toward the second position due to rotational inertia of the ratchet and the ratchet lever when an external force is applied to the ratchet,
further comprising a ratchet holding mechanism that abuts against the ratchet and thereby prevents ratchet from being rotated to the second position, and keeps the latch in the full-latched position, when the ratchet is rotated toward the second position by the external force; and
in door opening operation, the ratchet lever rotates the ratchet to the second position and presses the ratchet holding mechanism out of a trajectory of the ratchet.

5. A vehicle door latch apparatus according to claim 4, wherein the ratchet holding mechanism has an inertial lever that is opposite to the ratchet with a first gap therebetween and a blocking lever that is supported by the inertial lever via a connecting pin and that is opposite to the ratchet lever with a second gap therebetween, the second gap being smaller than the first gap,
further comprising:
a first spring that maintains the inertial lever at a position where the inertial lever is opposite to the ratchet and
a second spring having a larger elastic force than the first spring, wherein the second spring biases the blocking lever against the inertial lever in a direction opposite to a biasing force of the first spring,
in the door opening operation, the ratchet lever abuts against the blocking lever and rotates the inertial lever via the second spring to a position where the inertial lever is not opposite to the ratchet.

6. A vehicle door latch apparatus according to claim 5, wherein when the ratchet and the ratchet lever are rotated by the external force, the blocking lever is rotated against the second spring by being pushed by the ratchet lever and the inertial lever is kept at a position where the inertial lever is opposite to the ratchet.

7. A vehicle door latch apparatus according to claim 6, further comprising a stopper that can abut against the blocking lever, wherein when the ratchet lever abuts against the blocking lever at a pressing speed that is smaller than that when the external force is applied and that is larger than that when the door opening operation is conducted, the blocking lever is rotated against the second spring by being pushed by the ratchet lever, the inertial lever is rotated against the first spring, the blocking lever abuts against the stopper, and thereby the inertial lever is kept at a position where the inertial lever is opposite to the ratchet.

8. A vehicle door latch apparatus according to claim 5, wherein a center of gravity of an assembly of the blocking lever and the second spring matches a rotation center of the inertial lever.

9. A vehicle door latch apparatus according to claim 5, wherein the ratchet moves relative to the latch by a first distance until the ratchet is disengaged from the latch in the full-latched position, wherein the first gap is smaller than the first distance.

10. A vehicle door latch apparatus according to claim 4, wherein the ratchet and the ratchet lever are rotated from the first position toward the second position by a connector that is connected to the ratchet and that is displaced by a deformed vehicle panel.
